(19) United States
(12) Patent Application Publication
(10) Pub. No.: US 2002/0046252 A1
(43) Pub. Date: Apr. 18, 2002

(54) Repeater equipment

(76) Inventors: Masahiro Ono, Tokyo (JP); Kazuhiro Okanoue, Tokyo (JP); Hiroshi Mizuki, Tokyo (JP); Osamu Takahashi, Tokyo (JP); Koji Tsurumaki, Kanagawa (JP); Hiroshi Inamura, Kanagawa (JP); Katsumi Sekiguchi, Kanagawa (JP); Taro Ishikawa, Kanagawa (JP)

Correspondence Address: OSTROLENK FABER GERB & SOFFEN, 1180 AVENUE OF THE AMERICAS, NEW YORK, NY, 100368403

(21) Appl. No.: 09/977,587

(22) Filed: Oct. 15, 2001

(30) Foreign Application Priority Data
Oct. 16, 2000 (JP) 315494/2000

(51) Int. Cl. G06F 15/16

(52) U.S. Cl. 709/213; 709/219

(57) ABSTRACT

If the requested contents are present in a cache server those contents are sent to the client sending the request but if those contents are not present in the cache server the contents request message with the cache server set as the source is sent to a server, but an address conversion circuit operates to convert the source address of the message into the address of the client that actually issued the request.

### BACKGROUND OF THE INVENTION

1. Field of the Invention

This invention is used for repeating digital data transmission between servers for the Internet for example and a client. This invention relates to improvements for a repeater equipment providing a cache server for temporary storage of digital information provided by a server based on a request from a client. When signals with differing protocol, like HTTP (Hypertext Transfer Protocol, R. Fielding et al., “Hypertext Transfer Protocol—HTTP-1.1”, rfc 2068), or SMTP (Simple Mail Transfer Protocol, Jonathan B. Postel, “SIMPLE MAIL TRANSFER PROTOCOL”, rfc 821) are present in a signal transmitted from a client, this invention can be used as a repeater equipment providing functionality for identifying them.

2. Description of Related Art

For conventional server client type data transmission systems the client themselves must normally have cache memory for the purpose of lightening the load on the network, or a method is applied utilizing a repeater node with a caching function and repeating data between server and client.

When the client themselves has cache memory, whoever holds the client must strengthen the settings for cache memory but when there is a large number of clients this method is not suitable.

When utilizing a repeater node with a caching function a data transmission request is first transmitted to the repeater node as the data request of the client is performed. The repeater node sends the request to a server. The server transmits the data to the repeater node before the data is delivered on to the client. Through these processes the repeater node holds the data thus repeated for a certain period of time. When a request for the data thus repeated and held comes from the client the repeater node transmits that data being held to the client without issuing a request to the server. An issue for the client in this situation however is that settings requiring the one holding the client to perform complicated operations must be made to ensure that when the data request is made it passes via the repeater node.

A technology known as WCCP (Web Communication Control Protocol) exists to help avoid these complications, (see Cisco White Paper, “Network Caching and Cisco Network Caching Solutions”, HTTP://www.cisco.com/warp/public/cc/cisco/mkt/scale/cache/prodlit/cdsds.htm).

This conventional technology will now be described with reference to FIG. 6 .

A request for contents arises from client 1 and is delivered to server 3 as shown in FIG. 6. The message for this request passes through WCCP repeater equipment 2. When this happens repeater equipment 2 checks the port number of the destination that constitutes a process identifier for the destination for that request. If that port number corresponds to a port number previously set, an inquiry is performed to ascertain whether the requested contents are being held in cache server connected to repeater equipment 2.

If the contents requested by client 1 are present in cache server 4, cache server 4 delivers those contents to client 1 with the source address set as server 3. If appropriate contents are not present in cache server 4, repeater equipment 2 does not go via cache server 4 but delivers the contents request message to server 3 with the source address set as repeater equipment 2. Server 3 thus receiving the request, delivers the appropriate contents to repeater equipment 2. After repeater equipment 2 receives those contents they are forwarded to cache server 4 where the contents are stored.

Thereafter, if a request for these contents is made via repeater equipment 2, the contents are delivered from cache server 4 and repeater equipment 2 makes server 3 the source address of of the contents thus received and sends those contents to client 1.

It is possible for transmission between a client and server utilizing such a conventional WCCP repeater equipment to employ cache memory for lightening the load placed on the network, however the source address delivering the request message to the server is that of the repeater equipment and in a situation where the server would want to know where the contents request was actually coming from, if the objective is for billing for example, this method cannot be used.

### SUMMARY OF THE INVENTION

Against this background the present invention aims to provide a repeater equipment enabling acquisition of information useful for a process like billing, by operating with cache memory utilized in the processes for data transmission between a client and server, enabling the server to recognize the client where the contents request is actually coming from.

As a means for repeat control, the present invention provides two repeat control circuits that can be used for the purpose of cache memory between a client and server for example. When a repeat control circuit on a client side receives a contents request message from the client, if there is agreement with a previously set destination port number the message is delivered to a cache server via an address conversion circuit. At such times the address conversion circuit creates a table recording an identifier for the session and information about that which is shared with the cache server.

If the requested contents are present in the cache server those contents are delivered to the client, however if they are not present in the cache server the contents request message is sent to the server again with the cache server as the source, but because this message passes via the address conversion circuit the source address of the message is converted into the address of the client actually making the request.

Through the server side repeat control circuit, the server receiving the request message recognizes that a request message has been received from the client and sends the requested contents to the client.

When the repeat control circuit receives the requested contents, if there is agreement with a source port number set prior the message is delivered via the address conversion circuit to the cache server where it is stored.

Thereafter, the cache server sends the contents with the source address set as the server, via the address conversion circuit, to the client. The method thus described enables a server to recognize the client that actually sent the contents request message.

As described, where cache memory is utilized in the processes for data transmission between client and server, the server is able to recognize the client where the contents request is actually coming from. It thereby becomes possible to obtain information useful for billing operations for example, through collecting information on the client requesting data between a cache server and server.

In this way a first aspect of the present invention is a repeater equipment operating with a client terminal connected to a client, server terminals connected to servers and a cache server terminal connected to a cache server, which repeater equipment provides a repeat control means connected to the client side terminal, the server side terminal and the cache server side terminal;

wherein this repeat control means provides a means for repeating a request signal coming from the client side terminal to the cache server side terminal as well as a means for repeating digital information coming from the cache server side terminal that corresponds to that request signal, to the client side terminal connected to the client that delivered that request signal;

wherein the cache server provides a means for requesting from the server, forwarding of the appropriate digital information at times when digital information corresponding to that request signal is not stored within that cache server itself;

wherein the repeat control means provides a means for repeating to the server side terminal, this forwarding request signal from the means for requesting coming to the cache server side terminal as well as a means for forwarding digital information coming to the server side terminal that corresponds to the forwarding request signal, to the cache server side terminal; wherein the cache server provides a means for sending the digital information forwarded from the server with the address of the client that sent the request signal for the digital information;

and wherein the repeat control means provides a means for repeating digital information coming to the cache server to the client side terminal which is connected to the client with that address.

The present invention further comprises a means for writing address information on the client that is the source of the request for digital information requesting that forwarding operation, into the forwarding request signal.

Multiple server side terminals are provided to handle various different protocols and it is suitable to include in the repeat control circuit, a means for repeat connection to the appropriate terminal with the matching protocol from among the those multiple server side terminals in accordance with a process identifier included in the request signal coming from the client side terminal. The multiple protocols could include for example HTTP or SMTP.

The present invention can be realized by installing a control program that performs the described repeater operations in a digital processor in which an operating system is set and such a control program stored in a storage medium could be sold commercially.

### BRIEF DESCRIPTION OF THE DRAWINGS

Specific embodiments of the present invention will now be described, by way of example only, with reference to the accompanying of drawings in which:

FIG. 1 is a block diagram of a repeater equipment of an embodiment according to the present invention;

FIG. 2 is a block diagram of a routing control part of an embodiment according to the present invention;

FIG. 3 is a drawing showing an address conversion table shared by a cache server and an address conversion circuit;

FIG. 4 is a drawing showing the sequence occurring when the requested contents are not present in a cache server;

FIG. 5 is a drawing showing the sequence occurring when the requested contents are present in a cache server; and

FIG. 6 is a block diagram of a conventional repeater equipment.

### DETAILED DESCRIPTION OF THE PREFERRED EMBODIMENTS

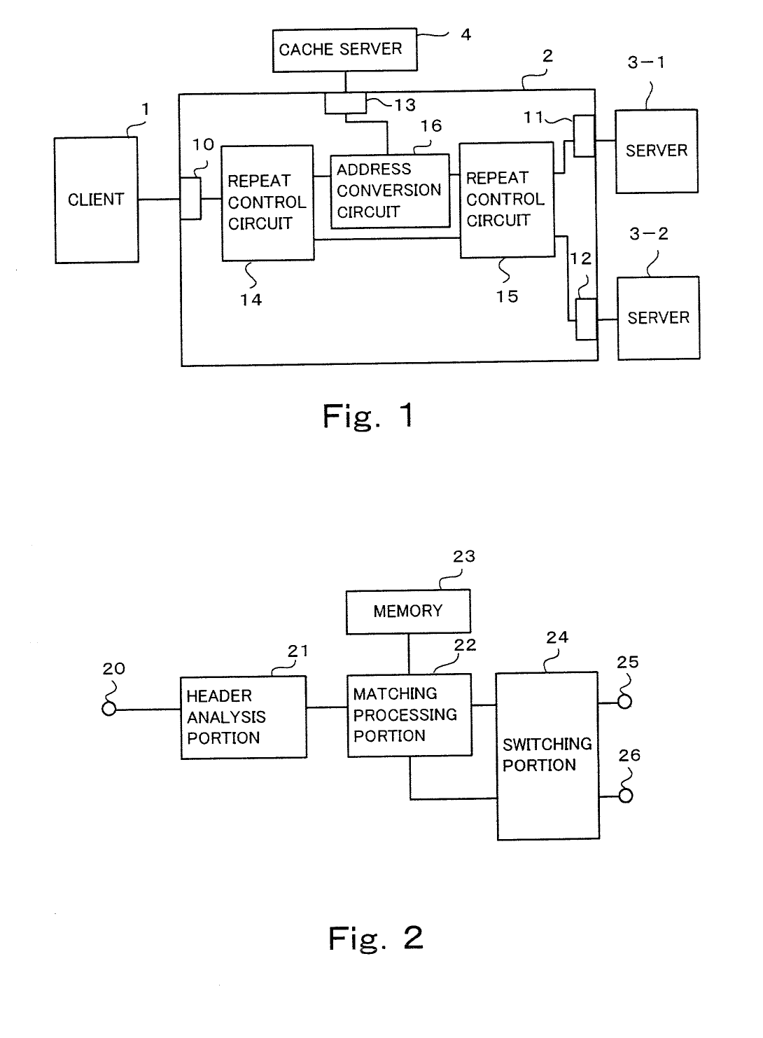

The configuration of a repeater equipment of an embodiment according to the present invention will now be described with reference to FIG. 1 and FIG. 2. FIG. 1 is a block diagram of a repeater equipment of an embodiment according to the present invention and FIG. 2 is a block diagram of a routing control part used in a repeat control circuit of an embodiment according to the present invention.

As shown in the FIG. 1 the present invention is repeater equipment 2 comprising client side terminal 10 connected to client 1, server side terminals 11 and 12 connected to servers 3-1 and 3-2 respectively, cache server side terminal 13 connected to cache server 4 and repeat control circuits 14 and 15 connected to client side terminal 10, server side terminals 11 and 12 and cache server side terminal 13 wherein:

repeat control circuits 14 and 15 repeat request signals coming into client terminal 10 to cache server side terminal 13 and repeat digital information coming from cache server side terminal 13 that corresponds to that request signal to client side terminal 10 to which is connected the client that delivered that request signal;

cache server 4 requests from servers 3-1 and 3-2 forwarding of the digital information at times when digital information corresponding to that request signal is not stored within that cache server itself;

repeat control circuits 14 and 15 repeat this forwarding request signal coming to cache server side terminal 13, to server side terminals 11 and 12, and forward digital information coming to server side terminals 11 and 12 that corresponds to the forwarding request signal to cache server side terminal 13;

cache server 4 provides a means for sending the digital information forwarded from servers 3-1 and 3-2 with the address of client 1 that sent the request signal for the digital information; and

repeat control circuits 14 and 15 repeat digital information coming to cache server side terminal 13 to client side terminal 10 to which is connected client 1 with that address.

The present invention further comprises address conversion circuit 16 for writing address information on client 1 that is the source of the request for digital information leading to that forwarding operation, into the forwarding request signal.

Multiple server side terminals 11 and 12 are provided to handle various different protocols and it is suitable to include in repeat control circuits 14 and 15, routing control circuitry as shown in FIG. 2 for repeat connection to the appropriate terminal with the matching protocol from among multiple server side terminals 11 and 12 in accordance with a process identifier included in the request signal coming from client side terminal 10. The multiple protocols include HTTP and SMTP.

A repeater equipment according to the present invention can be realized by installing a control program performing repeat operations of repeater equipment 2 in a digital processor in which an operating system is set. Such a control program stored in a storage medium could be installed in a digital processor to enable the present invention.

An embodiment of the present invention will now be described in detail.

The operations of a routing control circuit performing routing control based on the source port as shown in FIG. 2 will now be described. A source address, destination address and process identifier are present as a source port number and destination port number included as headers inside packets that are input in input terminal 20 before header analysis portion 21 implements processes to analyze the header portions of the packets. During this analysis processing the source port number is extracted which is then sent together with the packet to matching processing portion 22. A list of source packet numbers handled by routing control, e.g. port numbers coordinated for HTTP protocol, is accumulated in memory 23. In the matching processing portion 22 processes are performed matching the source port list handled by routing control obtained through accessing memory 23, together with source port numbers delivered from header analysis portion 21 and a decision is made whether or not routing control should be performed. Thereafter, the packets are sent to switching portion 24 together with routing control information. Switching portion 24 is connected to output terminals 25 and 26, however switching portion 24 may be connected to any desired number of output terminals. Switching portion 24 performs routing control on the packets by outputting each packet to either output terminal 25 or output terminal 26 as appropriate, based on the routing control information delivered by matching processing portion 22. This routing control circuit can be used as a circuit constructed by repeat control circuits 14 and 15 shown in FIG. 1.

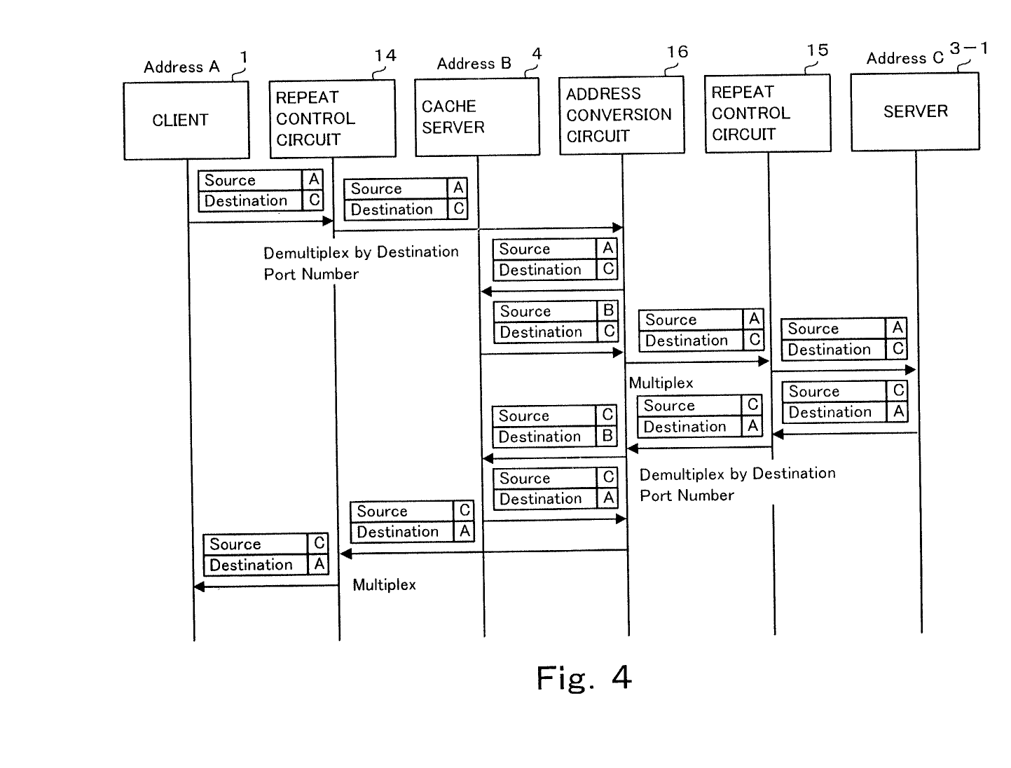

The operations of a repeater equipment according to an embodiment of the present invention will now be described. The first operation is for client 1 for example, where a browser utilizes HTTP protocol to request the contents of a file present in server 3-1 recorded with HTML (Hyper Text Markup Language, F. Yergeau et al., “Internationalization of the Hypertext Markup Language”, rfc 2070) but when the requested contents are not present in cache server 4. The sequence of operations that occurs in this situation is shown in FIG. 4. The boxes appearing above the arrows in FIG. 4 show a source address and destination address for each message. Repeat control circuit 14 is set to perform routing control to address conversion circuit 16 for an HTTP protocol source port number. After address conversion circuit 16 performs those processes required when there is no input from cache server 4, the received message is forwarded to cache server 4. For an HTTP protocol source port number, repeat control circuit 15 is set to perform routing control to address conversion circuit 16.

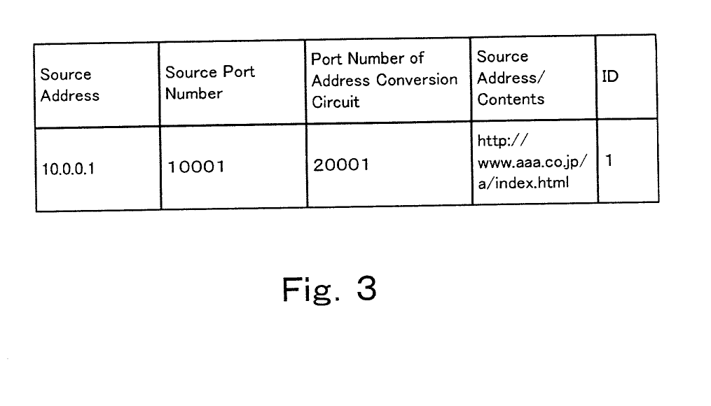

Repeat control circuit 14 sees the port number of the message coming from client 1 and if HTTP protocol is recognized that HTTP protocol message is forwarded to address conversion circuit 16. When the address conversion circuit 16 receives the HTTP protocol message that message is forwarded to cache server 4. In this situation address conversion circuit 16 creates a client/server table which it shares with cache server 4, showing the corresponding address and port number of source client 1, the port number allocated for this session in address conversion circuit 16, the destination address/contents and a session identifier ID as shown in FIG. 3 for example. Information on each session can be shared between cache server 4 and address conversion circuit 16 through this ID. Cache server 4 receiving the forwarded http protocol message together with the respective ID and recognizing that this HTTP protocol message is a message from client 1 requesting contents of server 3-1, implements a referencing operation on the cache, but since those requested contents are not present there cache server 4 then delivers a contents request message for which the source address is made cache server 4 and destination address server 3-1 together with an ID for that message, to address conversion circuit 16.

At address conversion circuit 16 as the contents request message forwarded from cache server 4 is received the ID is checked, a reference operation is performed on the client/server table and a request message with the source address set to client 1 and the source port number set to the port number allocated by that address conversion circuit 16 itself previously, is sent to server 3-1. Server 3-1 receiving this contents request message sends the requested contents in a responding message in which the source address is set to server 3-1 and the destination address is set to client 1.

As this message passes through repeat control circuit 15 the source port number is checked and recognized as being HTTP protocol. Because this corresponds to the HTTP protocol port number set prior the message is sent to address conversion circuit 16. At address conversion circuit 16 a referencing operation is conducted on the client/server table for the client address that is the destination address and the port number allocated by address conversion circuit 16 that is the destination port number. An ID is appended and after the destination address is amended to be cache server 4, the message is forwarded to cache server 4. At cache server 4, once the contents required for which request are recognized from the ID, those contents are held in cache.

Cache server 4 forwards the contents via the address conversion circuit 16 where the message has the source address set as server 3-1 and the destination address set as client 1 before delivery to client 1.

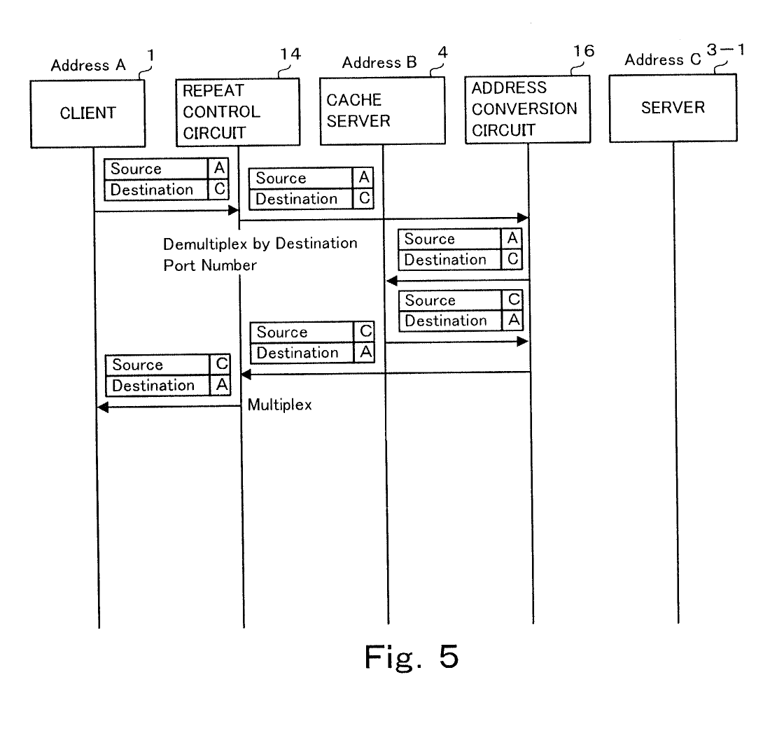

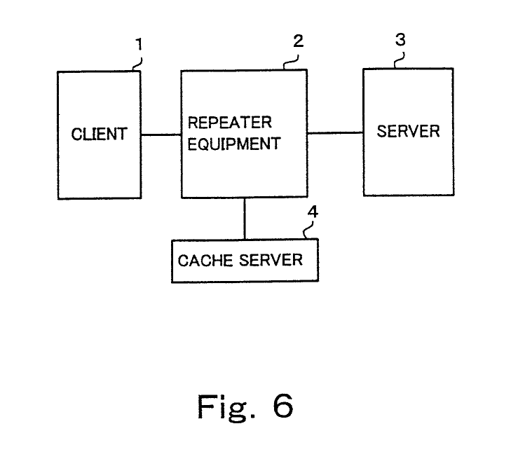

The second operation, for client 1 for example, applies where a browser utilizes HTTP protocol to request the contents of file present in server 3-1 recorded with HTML and the requested contents are present in cache server 4. The sequence of operations that occurs in this situation is shown in FIG. 5. The boxes appearing above the arrows in FIG. 5 show a source address and destination address for each message. In the same way as for the first operation, repeat control circuit 14 is set to perform routing control to address conversion circuit 16 for an HTTP protocol source port number. After address conversion circuit 16 performs those processes required if there is no input from cache server 4, the received message is forwarded to cache server 4.

Repeat control circuit 14 sees the port number of the message coming from client 1, recognizes HTTP protocol and forwards the message to address conversion circuit 16. When address conversion circuit 16 receives the message it is forwarded, after creation of a client/server table in the same way as for the first operation, to cache server 4.

Cache server 4 recognizes the message as the contents request message for server 3-1 coming from client 1 and because the contents requested is present in cache server 4, sends to address conversion circuit 16 a message containing the requested contents with the source address set to server 3-1 and the destination address set to client 1. Address conversion circuit 16 forwards the message to client 1.

The third operation is for sending a message that uses a destination port number not registered in advance for client 1. Here the protocol is for example SMTP, and the message is sent with the source address set as client 1 and destination address set as server 3-2. In this situation there is no correspondence with a destination port number set in advance for repeat control circuit 14, so the message undergoes routing control directing it to repeat control circuit 15. The message thus passes through repeat control circuit 15 and is delivered to server 3-2. From server 3-2 to client 1 the message is sent to repeat control circuit 15 where the destination port number is checked but because this port number is different to an HTTP port number the message next passes via repeat control circuit 14 before arriving at client 1.

It is also suitable for the above three examples for address conversion circuit 16 and cache server 4 to physically be one node.

As described, server 3-1 is able to recognize that the one requesting delivery of contents is client 1 and data transmission between client and server that places a lower burden on the network is realized.

As described above the present invention operates with cache memory utilized in the processes for data transmission between a client and server, allowing the server to recognize the client where the contents request is actually coming from, enabling acquisition of information useful for things like billing operations.

What is claimed is:

1. A repeater equipment comprising a client side terminal connected to a client, server side terminals connected to servers, a cache server side terminal connected to a cache server and repeat control means provided in between said client side terminal, said server side terminals and said cache server side terminal; wherein
said repeat control means provides a means for repeating a repeat request signal coming into said client side terminal to said cache server side terminal and a means for repeating digital information coming into said cache server side terminal that corresponds to that request signal to said client side terminal which is connected to the client that delivered that request signal;
said cache server provides a means for requesting from said servers, forwarding of the appropriate digital information at times when digital information appropriate to said request signal is not stored within said cache server itself;
said repeat control means provides a means for repeating to said server side terminals, this forwarding request signal of said means for requesting coming to said cache server side terminal, and a means for repeating digital information coming to said server side terminal that corresponds to the forwarding request signal to said cache server side terminal;
said cache server provides a means for sending said digital information forwarded from said servers with the address of the client that sent the request signal for the appropriate digital information; and
said repeat control means provides a means for repeating digital information coming to said cache server side terminal to said client side terminal which is connected to the client with that address;
which is provided an address conversion circuit for writing address information on the client that is the source of the request for digital information leading to that forwarding operation, into said forwarding request signal.

2. A repeater equipment according to claim 1 wherein multiple said server side terminals are provided for handling multiple different protocols and wherein said repeat control means includes a means for repeating to the appropriate terminal with matching protocol from among said multiple server side terminals in accordance with a process identifier included in the request signal coming from said client side terminal.

3. A repeater equipment according to claim 2 wherein said multiple protocols include HTTP and SMTP.

4. A storage medium in which is stored a control program which when stored in a digital processor in which an operating system is set allows the digital processor to operate as a repeater equipment according to claims 1 through 3.
